(19) United States
(12) Patent Application Publication
(10) Pub. No.: US 2019/0217441 A1
(43) Pub. Date: Jul. 18, 2019

(54) ROBOTIZED HAMMERING METHOD AND ROBOTIZED SYSTEM FOR IMPLEMENTING THE METHOD

(71) Applicant: SONATS - SOCIETE DES NOUVELLES APPLICATIONS DES TECHNIQUES DE SURFACE, Carquefou (FR)

(72) Inventors: Paul LEFEVRE, Orvault (FR); Vincent DESFONTAINE, Les Sorinieres (FR); Patrick CHEPPE, Basse-Goulaine (FR)

(73) Assignee: SONATS - SOCIETE DES NOUVELLES APPLICATIONS DES TECHNIQUES DE SURFACE, Carquefou (FR)

(21) Appl. No.: 16/318,750

(22) PCT Filed: Jul. 21, 2017
(86) PCT No.: PCT/EP2017/068459

§ 371 Date: Jan. 18, 2019

(30) Foreign Application Priority Data
Jul. 21, 2016 (FR) 1656934

(51) Int. Cl. B24C 1/10; B23P 9/04; B23K 31/02; B24B 39/00; C21D 9/50; C21D 7/04

(52) U.S. Cl. CPC B24C 1/10; B23P 9/04; C21D 7/04; B24B 39/006; C21D 9/50; B23K 31/02

(57) ABSTRACT

A robotised hammering method for hammering a weld seam (C) made on a base surface (S) of a metal workpiece (V) using a robotised system (32), comprising the following steps:—controlling the robotised system (32) provided with an effector (35; 38) carrying a scanning tool (30) in such a way as to follow, with the scanning tool (30), an initial path along the weld seam (C), said initial path having been determined from the digital model of the workpiece or from the actual workpiece,—acquiring, by means of the scanning tool (30), along the initial path, local data concerning the elevation and position of the weld seam and of the area or areas of the base surface close to the weld seam,—calculating, from the elevation and position data acquired in this way and from the initial path, a corrected path, and—controlling the robotised system (32) provided with an effector (40; 38) carrying a hammering tool (41) to hammer the weld seam along this corrected path.

### FIELD OF THE INVENTION

The present invention relates to the methods, systems and installations intended for the robotized treatment of welds by high-frequency peening.

The aim of high-frequency peening is to enhance the fatigue behavior of mechanically welded workpieces. It is a cold mechanical treatment which consists in striking the surface of a metal part and more particularly the root of the weld bead with one or more micro-strikers of high kinetic energy, also called needles or impactors, to release the tensile stresses located in the heat-affected zone (ZAT) by performing, on the one hand, a cold working which induces compression stresses and, on the other hand, a geometrical modification ensuring a progressive transition between the base metal and the weld bead.

### Disadvantages of the Prior Art and Aims of the Invention

Established or current studies show that high-frequency peening ensures improved fatigue behavior, through an action delaying the initiation of cracks and the propagation thereof.

Needles, generally with spherical head held in the treating head, are projected at high speed and at high frequency against the weld in order to peen the zone. This controlled treatment ensures an extension of the life of the welded components through the combined effect of the geometrical modification of the transition between the base metal and the weld bead and of the introduction of beneficial compression stresses in the heat-affected zone. In particular, the high-frequency peening activated by ultrasounds is one of the best preventive treatments for improving the fatigue strength of the mechanically welded workpieces.

The peening operation is generally performed manually. The manual implementation of the peening requires the availability of qualified operators. The peening cannot be implemented on long runs but essentially on unitary workpieces. Furthermore, monitoring and quantifying peening quality in manual operations is complex.

A robotized peening method is known from US2011/0123820 that uses an impactor with a determined geometry.

There is a need to robotize this operation and to be able to implement it in mass production, with more accurate traceability, and better quality control.

### SUMMARY OF THE INVENTION

Method

The present invention thus relates, according to a first of its aspects, to a method for robotized peening of a weld bead produced on a base surface of a metal workpiece, using a robotized system, comprising the following steps:
controlling the robotized system provided with an effector bearing a scanning tool so as to follow, with the scanning tool, an initial trajectory along the weld bead, this initial trajectory having been determined from the numerical model of the workpiece and using, for example, offline programming tools (PHL), or else from the real workpiece, in particular by manual learning,
acquiring, using the scanning tool, along the initial trajectory, local data on the relief and position of the weld bead and on the zone or zones of the base surface in proximity to the weld bead,
calculating, from the relief and position data thus acquired and from the initial trajectory, a corrected trajectory, and
controlling the robotized system provided with an effector bearing a peening tool to peen the weld bead along this corrected trajectory.

By virtue of the invention, there is a robotized peening method that is fast, accurate and reliable. The trajectory followed by the peening tool is perfectly suited to the weld bead to be treated, by virtue of the steps of acquisition of the local data on the relief and position of the weld bead and its near environment and of calculation of the corrected trajectory. The trajectory may be calculated on the basis of the real position and orientation of the weld bead and the surrounding surfaces and geometries of the workpiece, in particular of the root of the weld bead and on the basis of the accessibility of the bead for the peening tool.

The initial trajectory is advantageously that of a peening tool.

The local data on the relief and position of the weld bead and on the adjacent zone or zones of the base surface of the workpiece may comprise, for any point of the weld bead, the spatial coordinates of the root of the weld bead and the angle formed at the root between the weld bead and the base surface of the workpiece. The root in fact forms the end of the weld bead, being situated at the limit between the weld bead and the base surface of the workpiece.

These geometrical data make it possible to deduce the spatial coordinates of the bisector of the angle formed at the root between the weld bead and the base surface of the workpiece, at each point of the weld bead root. Knowing the spatial position of the root and of the bisector, it is possible to deduce therefrom the so-called detection axis for each point of the root, composed of a straight line passing through this point and coinciding with the bisector. It is also possible, for smoothing the corrected trajectory by discarding certain very local defects, to apply a filter to a succession of points.

“The zone or zones of the base surface in proximity to the weld bead” should be understood to mean the part or parts of the base surface of the workpiece, situated for example from the root of the weld bead to a distance less than 100 mm from the weld bead, on one side thereof or on both sides, on either side of the weld bead. This or these zone or zones may form a strip alongside the weld bead or two strips on either side thereof. They may extend in a particular embodiment to a distance of approximately 8 mm from the weld bead. In another embodiment, this or these zone or zones may extend to a distance of approximately 60 mm from the weld bead.

The method may also comprise, before the peening step, a step of monitoring the corrected trajectory consisting in:
controlling the robotized system provided with the effector bearing the scanning tool so as to follow, with the scanning tool, the corrected trajectory,
acquiring, using the scanning tool, along the corrected trajectory, local data on the relief and position of the weld bead, and
comparing the new scanned trajectory and the corrected trajectory.

If appropriate, if necessary, in particular if the corrected trajectory does not coincide with the new local data on the relief and position of the weld bead, the corrected trajectory may be corrected once again.

The step of monitoring of the corrected trajectory may also comprise the taking of geometrical measurements of the surface to be peened.

The surface to be peened may include the weld bead around the root and the base surface in immediate proximity to the root or, as a variant, the base surface to a maximum distance from the root of approximately 10 mm.

The method may also comprise a differential calculation step making it possible to calculate the differential deviation between the initial trajectory and the real position making it possible to achieve the corrected trajectory.

After the peening step, the method may also comprise a quality control step consisting in controlling the robotized system provided with the effector bearing the scanning tool so as to acquire local data on the relief and position of the peened weld bead, in order to monitor and quantify the quality thereof.

In this case, and in the case where a step of monitoring of the trajectory has been performed with the taking of geometrical measurements of the surface to be peened, the quality control step may comprise the taking of geometrical measurements of the peened surface, and the comparison with the geometrical measurements of the surface to be peened, in order to conclude on the quality of the peening. The geometrical measurements are taken in such a way as to be comparable, between those of the surface to be peened and those of the peened surface.

The peening forms, by the high frequency impact on the root of the weld bead, a hollowed-out line, called undercut or furrow, having a depth, generally lying between 0.1 and 0.5 mm, and a radius generally lying between 1 and 3 mm, the depth and the radius of the undercut being linked to the force of the impact, to the frequency and to the rate of displacement, the undercut also having a width linked to the penetration into the material and to the diameter of the impactor or impactors. Thus, it is possible to define predetermined target values, particularly for the radius and the depth of the undercut, depth at the level of the weld bead and depth at the level of the base surface. Then, with the two takings of geometrical measurements of the surface before and after peening and the comparison thereof, it is possible to calculate the values such as the radius and the depth and compare them with the predetermined target values. A predefined margin of error may be accepted. After the predetermined target values and this margin of error have been taken into account, it is possible to conclude whether the quality of the peening is deemed satisfactory or not. The geometrical measurements taken are such that they may make it possible to calculate the radius and the depth of peening at the weld bead and the base surface, by comparison.

By virtue of the invention, there is an increased capacity to be able to monitor upstream, that is to say before peening, and downstream, that is to say after peening, the geometrical measurements.

If the quality of the peening is deemed insufficient, the method may comprise a subsequent step of peening of all or part of the peened surface by control of the robotized system provided with the effector bearing the peening tool along the corrected trajectory.

The method may comprise a step of control of the robotized system provided with an effector bearing a grinding or milling tool along the corrected trajectory in order to perform a finishing of the peened surface. The aim of this finishing operation is to eliminate the material folds created by the peening while retaining the compression stresses of the zone or surface peened.

In a particular embodiment, the method comprises at least one step of changing of effector, the robotized system being provided either with an effector bearing the peening tool capable of performing the peening step or steps, or with an effector bearing the scanning tool capable of performing the step or steps of acquisition of local data on the relief and position of the weld bead. Likewise, when a grinding or milling step is provided, the method may comprise a step of changing of effector before performing the grinding step, the robotized system being provided, for this step, with an effector bearing a grinding or milling tool.

In this case, the effectors bearing the peening and scanning tools, and possibly grinding or milling tools, are advantageously configured and linked to the robotized system so as to have the same tool reference point, or tool center point (TCP). That makes it possible to exploit the property of repeatability of the robot to perform the successive steps of the method with the different effectors. Also, the changing of effector makes it possible to eradicate the vibrations of the peening to perform the scan.

As a variant, the method may not comprise a step of changing of effector, the robotized system then being provided with an effector bearing at least the peening tool and the scanning tool, and, if appropriate, the grinding or milling tool.

The method may comprise a step, when the scanning tool is following the initial trajectory, consisting in automatically detecting weld defects on the weld bead. This step may consist in making it possible, via the bead location algorithm, to detect a zone of the weld bead comprising a succession of aberrant points, linked to the defect(s). In this case, the method may comprise the step consisting in controlling, in the peening step, a displacement along an axis allowing a disengagement of the tool without the latter interfering with the workpiece being treated or the environment in order not to treat the zone by peening. This axis is generally the main axis of the peening tool or the main axis of the impactor or impactors.

In this case, the method may comprise the step consisting in transmitting, via a human-machine interface (HMI), an item of information, intended for the operator, according to which an identified zone of the weld bead has not been treated by peening. This zone will be able to be corrected and treated subsequently, manually or automatically, after correction of the identified defect or defects. The method may comprise the step consisting in representing, on a 3D view of the workpiece or on a 3D reconstruction of the trajectory, the location of the identified defect or defects.

Robotized System

Another subject of the invention, in combination with the above, is a robotized system for implementing the method as defined above, comprising at least one effector comprising at least:
a scanning tool configured to acquire local data on the relief and position of the weld bead, and
a peening tool configured to perform a peening treatment of said weld bead. The robotized system, also called robot, may be defined as a poly-articulated mechanical system driven by actuators and controlled by a computer which is intended to perform a wide variety of tasks.

The robotized system may comprise a robotized arm. The precision of a robotized arm, in its absolute position, is generally greater than 1 mm. Such imprecision may be due to geometrical model errors, errors in quantification of the position measurement and/or flexibilities.

The repeatability of a robot is the maximum error of repeated positioning of the tool at any point of its workspace. Generally, the repeatability is less than 1 mm, even 0.1 mm, therefore comparatively better than the precision of the robotized system. The robotized system may, as a variant, comprise a machine-tool gantry, or other type of robotized system comprising multiple displacement axes.

“Effector” should be understood to mean a system fixed removably to the robotized system, in particular at the end of the arm of the robot, and actuated by the robot.

The robotized system may be provided alternatively with an effector bearing said at least one scanning tool and with an effector bearing said at least one peening tool. The effectors bearing the scanning tool and the peening tool may be configured such that the tool center point (TCP) is identical for the effector bearing the peening tool and the effector bearing the scanning tool. As indicated above, that makes it possible to rely on the repeatability of the robot, generally better than the precision of the robot, for the peening operation.

The robotized system may comprise an effector bearing a grinding or milling tool.

In a particular embodiment, the robotized system is alternatively provided with the effector bearing the scanning tool or the peening effector, or, if appropriate, with the effector bearing the grinding or milling tool.

As a variant, the robotized system is provided with a combined effector which incorporates the peening and scanning functions simultaneously. The effector may comprise in particular two scanning tools situated on either side of the peening tool, in the direction of relative advance of the robotized system in the peening step. In this case, the robotized system may also be provided with the grinding or milling tool.

It should be noted that the robotized system may, if appropriate, be used to perform the welding before the peening, it then being linked to an effector bearing a welding tool. In this case, or in that where two different robots are used, one for the welding and one for the peening, the trajectory of the welding tool may be similar to the trajectory of the peening tool.

The robotized system may comprise a compliance provided to maintain the contact between the peening tool and the weld bead during the peening and to monitor the contact force. In this case, the compliance is for example positioned in the detection axis, resulting from the spatial position of the root of the weld bead and of the bisector. The compliance may comprise a passive or active damping means. The calibrated force of contact at rest, that is to say when the peening is not active, between the peening tool and the weld bead is monitored so as to preferably lie between 1N and 500N, better between 2N and 200N and usually used between 70N and 100N. In particular when there is no changing of effector, the compliance may be useful because it makes it possible to attenuate vibrations provoked by the peening.

The robotized system may comprise an angular compliance, arranged to deflect, if necessary, the peening tool toward the root of the weld bead to be treated in a plane substantially orthogonal to the bead, the angular compliance allowing an angular play of the peening tool lying between 0 and 30°, better between 0 and 5° This angular compliance may be produced from two plates pivoting relative to one another about an axis and having fixed damped end stops. The axis will preferentially intersect and be at right angles to the main axis of the peening tool. The damping may be produced by flexible end stops of elastomer type or by mechanical system, such as by gas dampers or springs for example. The damping system must allow the tool to be maintained in nominal position whatever its spatial orientation and ensure a moment on the tool about the rotation axis preferably lying between 0.1 Nm and 1000 Nm, better between 1 Nm and 100 Nm.

The scanning tool is advantageously chosen from the group composed of the contact-based relief and position data acquisition systems, such as mechanical feelers, and the contactless relief and position data acquisition systems, such as optical sensors, in particular laser or camera, inductive sensors, capacitive sensors.

The rate of advance of the peening tool along the weld bead during the peening operation may lie between 1 and 40 mm/s, preferably between 5 and 10 mm/s.

The high-frequency peening technology of the peening tool is advantageously chosen from the group composed of ultrasound peening, pneumatic peening, linear mechanical peening and linear electric motor peening. In the ultrasound or pneumatic high-frequency peening techniques, the impactors, in particular with hemispherical head, are captive to the treatment head and projected against the weld respectively by virtue of the vibration of the sonotrode or of a pneumatic actuator in order to peen the zone.

In the linear motor technique, the impactors may be fixed to or propelled by the carriage of the linear motor, the impactors are held in the tool and moved by the magnetic carriage of the motor.

For all these techniques, the impact frequency of the impactors may lie between 1 and 1000 Hz, preferably between 50 and 400 Hz.

In addition, when the high-frequency peening technology is ultrasound-based, the peening tool may comprise between 1 and 50 needles, preferably between 1 and 5 needles, better just one needle. These needles have a diameter lying between 0.5 and 20 mm and preferably between 1 and 10 mm, and an impact radius lying between 0.25 and 100 mm and preferably between 1 and 10 mm. In this case also, the vibration frequency of the acoustic assembly may lie between 10 kHz and 60 kHz, preferably between 20 kHz and 40 kHz. Still in this case, the vibration amplitude may lie between 5 and 200 μm peak-to-peak, preferably between 15 and 60 μm peak-to-peak.

The robotized system may comprise a counterweight system configured to compensate the weight of the peening tool whatever the orientation thereof. That may thus make it possible to cancel or limit the effect of gravity on the effort applied by the impactor on the treated zone. By virtue of this counterweight system, the effort of the peening effector on the workpiece may be more easily controlled.

### BRIEF DESCRIPTION OF THE FIGURES

The invention will be able to be better understood on reading the following description, of nonlimiting exemplary implementations thereof, and on studying the attached drawing, in which:

FIG. 1 represents, in the form of a functional diagram, different steps of the method according to an exemplary implementation of the invention,

FIG. 2 schematically represents, partially and in perspective, a scanner of a part of weld bead,

FIG. 3A represents, in schematic transverse cross section, the weld bead of FIG. 2, before peening,

FIG. 3B partially represents, in transverse cross section and schematically, the weld bead of FIG. 2 after peening,

FIG. 4 represents, schematically and in perspective, an effector bearing a scanning tool used in the implementation of the method of FIG. 1,

FIG. 5 represents, schematically and in perspective, an effector bearing a peening tool used in the implementation of the method of FIG. 1,

FIG. 6 illustrates, by a functional diagram, another exemplary implementation of the method according to the invention,

FIG. 7 schematically represents, partially and in perspective, an example of an effector bearing the peening tool and the scanning tool or tools for the implementation of the method illustrated in FIG. 6,

FIG. 8 is a schematic and perspective bottom view of the effector of FIG. 7,

FIG. 9 illustrates, partially, schematically and in a perspective view, a production line with robots each provided with a robotized system according to an example of the invention,

FIGS. 10 and 11 schematically represent the trajectories, respectively real and initial after scan, and real and corrected after correction,

FIG. 12 represents, schematically and in perspective, a weld bead after peening,

FIG. 13 schematically and partially represents, in cross section, a weld bead root after peening,

FIG. 14 represents the weld bead root of FIG. 13 after grinding,

FIGS. 15 and 16 schematically represent, in perspective, two examples of tools that may be used for the grinding or milling step,

FIG. 17 is a schematic view of a graph of fatigue behavior in relation to the effort of pressure of a weld peened and/or ground or not,

FIGS. 18 and 19 respectively schematically represent the effector bearing the scanning tool and the effector bearing the peening tool linked to the robotized system and having the same TCP,

FIGS. 20 and 21 represent, schematically in plan view, different examples of weld beads treated by peening using the method according to the invention,

FIG. 22 is a schematic diagram illustrating the robotized system comprising a counterweight system, and

FIG. 23 is an enlarged view of a detail of FIG. 22.

### DETAILED DESCRIPTION OF EMBODIMENTS

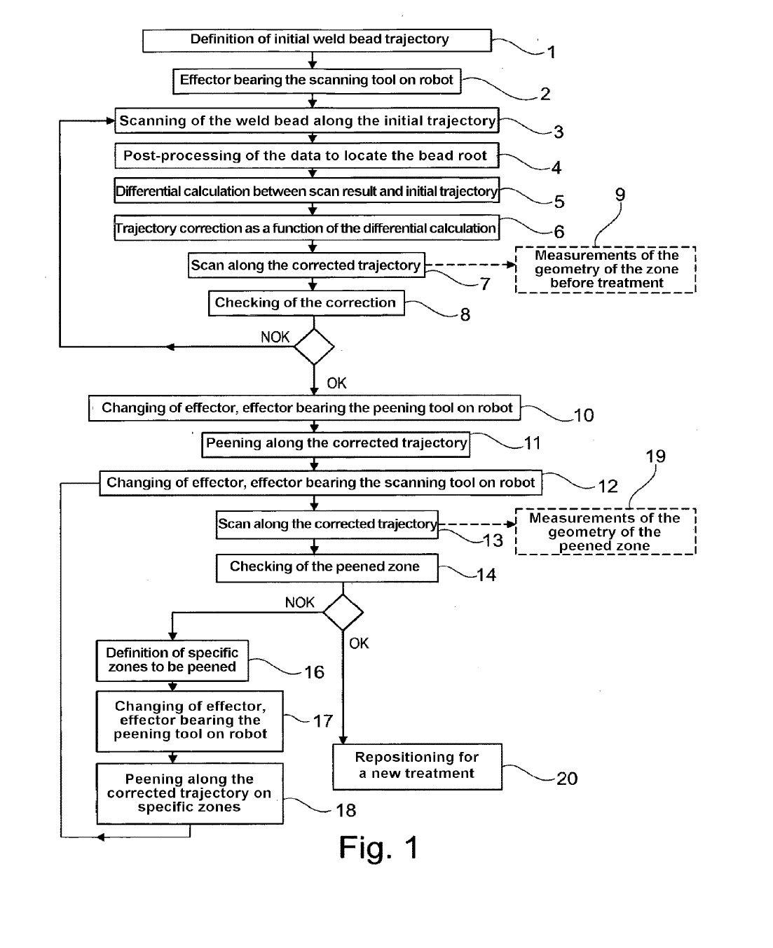

FIG. 1 shows the different steps of the method for robotized peening of a weld bead performed on a base surface of a metal workpiece, using a robotized system, according to an exemplary implementation of the invention.

In this example, the method comprises a step 1 consisting in defining the initial trajectory of the part or parts of the weld bead which will be treated by peening. The initial trajectory is the trajectory of a peening tool used in the subsequent peening operation. This initial trajectory, which is theoretical, is determined from the numerical model of the workpiece and using, for example, offline programming tools (PHL), or else from the real workpiece by manual learning.

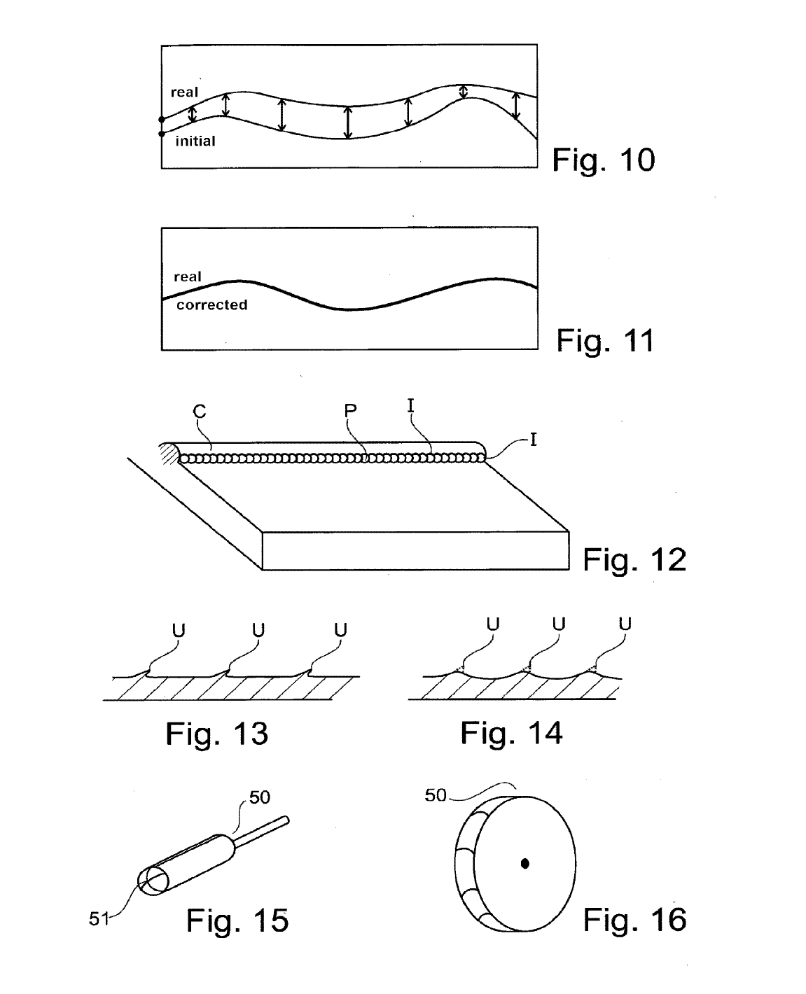

In a step 2, an effector bearing a scanning tool is fixed removably onto a robotized system so as to be able, in a step 3, to control the robotized system provided with the effector bearing the scanning tool so as to scan the weld bead to be treated by following the initial trajectory which was defined in the step 1. The scanner of the weld bead will make it possible to acquire, by virtue of the scanning tool, local data on the relief and position of the weld bead and on the zones of the base surface of the workpiece which are adjacent thereto. A schematic example of curve illustrating the deviation between the plots of the real trajectory and of the initial trajectory has been illustrated in FIG. 10. In this figure, the plot of the initial trajectory has been represented at the bottom and that of the real trajectory at the top. These plots are not fully overlaid, with a deviation illustrated by the larger or smaller double-headed arrows between the two plots. Obviously, FIG. 10 shows only the trajectories in two dimensions but the acquisition of local data on the relief and position of the weld bead make it possible to access the spatial coordinates in three dimensions of the weld bead and of its near environment, in particular over the weld bead root and of the angle formed between the weld and the surface of the workpiece, at the root.

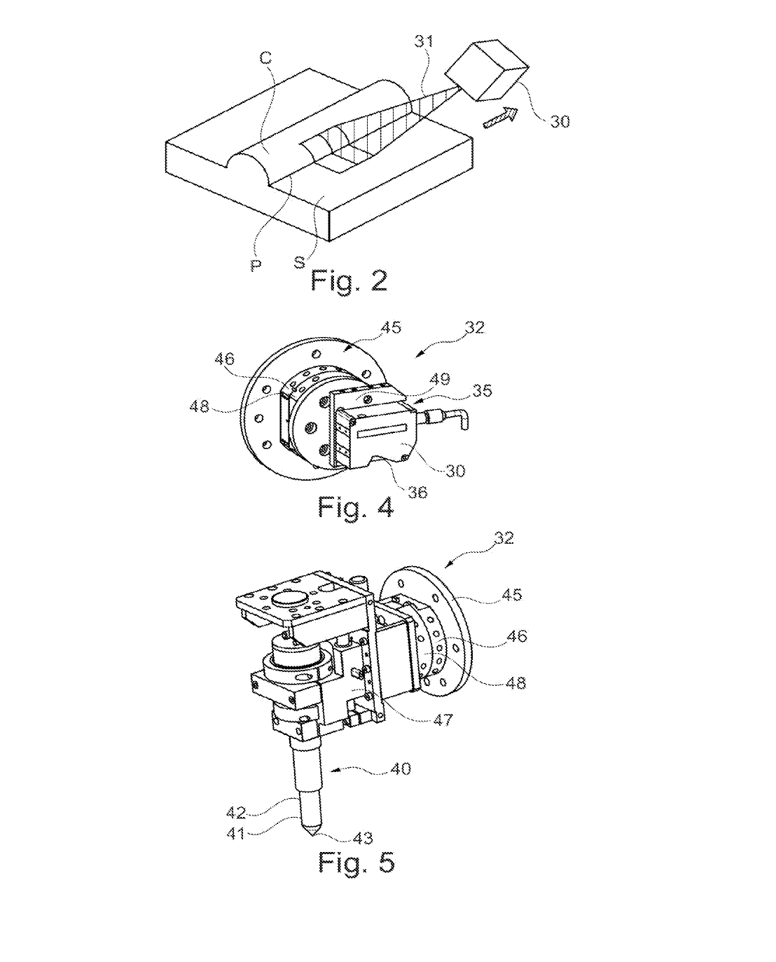

FIG. 2 very schematically illustrates the scan using the scanning tool 30 composed of a system for acquiring relief and position data performing a scan 31 of the weld bead C, more particularly of the root P consisting of the zone extending to the join between the weld bead C and the base surface S of the metal workpiece on which the weld has been produced.

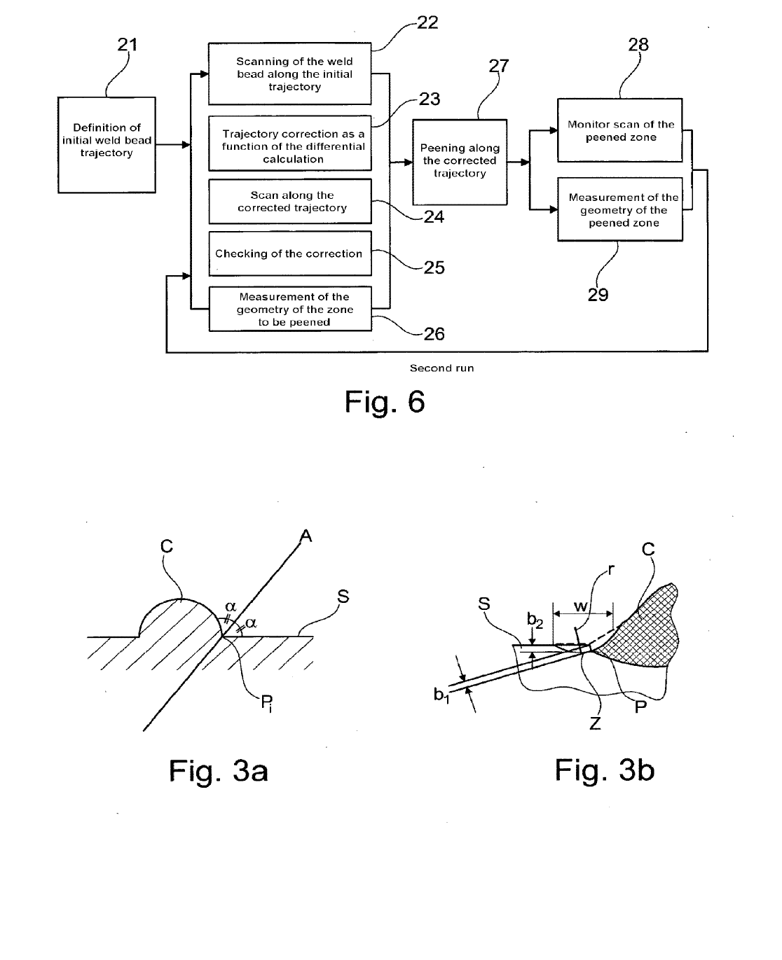

When the scan of the weld bead is performed, the aim is to obtain, as illustrated in FIG. 3A, local data on the relief and position of the weld bead and its near environment, in particular the positioning in three dimensions of the weld bead root, at any point Pᵢ of the weld to be peened, and also the angle 2*a formed between the weld and the workpiece, at the root, in order to determine the coordinates in three dimensions of the bisector, at any point Pᵢ of this root, consisting of the half-line passing through the root with equiangle a between the surface S and the weld bead C at the root P. Thus, through this scan, it is possible to know the three-dimensional coordinates of the point Pᵢ and also those of the straight line A, forming the detection axis, of orientation coinciding with that of the bisector passing through Pᵢ.

To perform the scan, the effector bears a scanning tool 30 which may be a contact-based relief and position data acquisition system, for example comprising mechanical feelers, or a contactless relief and position data acquisition system, such as optical sensors, in particular laser or cameras, inductive sensors or capacitive sensors, or another contact-based or contactless location system. In the example illustrated, the effector 35 illustrated in FIG. 4 comprises a scanning tool 30 composed of an optical sensor 36 consisting of a laser ray and a camera.

In a step 4, a post-processing of the acquired data is performed to locate the root P of the weld bead C.

In a step 5 illustrated in FIG. 1, and based on the acquired data on the relief and position of the weld bead C and on the post-processing, the difference is calculated between the result of the scan, that is to say the real trajectory, and the initial trajectory. The result of this differential calculation is a correction of the initial trajectory, in a step 6, which will make it possible to obtain a corrected initial trajectory, the plot of which is illustrated schematically in FIG. 11 as being superimposed on that of the real trajectory modulo the accuracy achieved by the installation as a whole.

In a step 7, the scanning tool is used again to scan by following the corrected trajectory in order to check, in a step 8 of FIG. 1, that the correction is correct. If the latter is not correct, indicated “NOK” in FIG. 1, there is a return to the step 3 as illustrated and the steps 3, 4, 5, 6 and 7 are implemented again until the correction is acceptable, indicated “OK” in FIG. 1, in which case the implementation of the method may be continued.

Moreover, this step 7 may make it possible to obtain output data illustrated in the box 9 of FIG. 1, namely geometrical measurements of the zone or surface to be peened, before treatment.

When the correction checked in the step 8 is correct, there is a transition to the step 10 of changing of effector so as to fix an effector bearing a peening tool onto the robotized system.

An example of effector 40 bearing a peening tool 41 has been illustrated in FIG. 5. It should be noted that the high-frequency peening technology may consist of an ultrasound, pneumatic, linear mechanical or linear electric motor peening, preferably ultrasound peening.

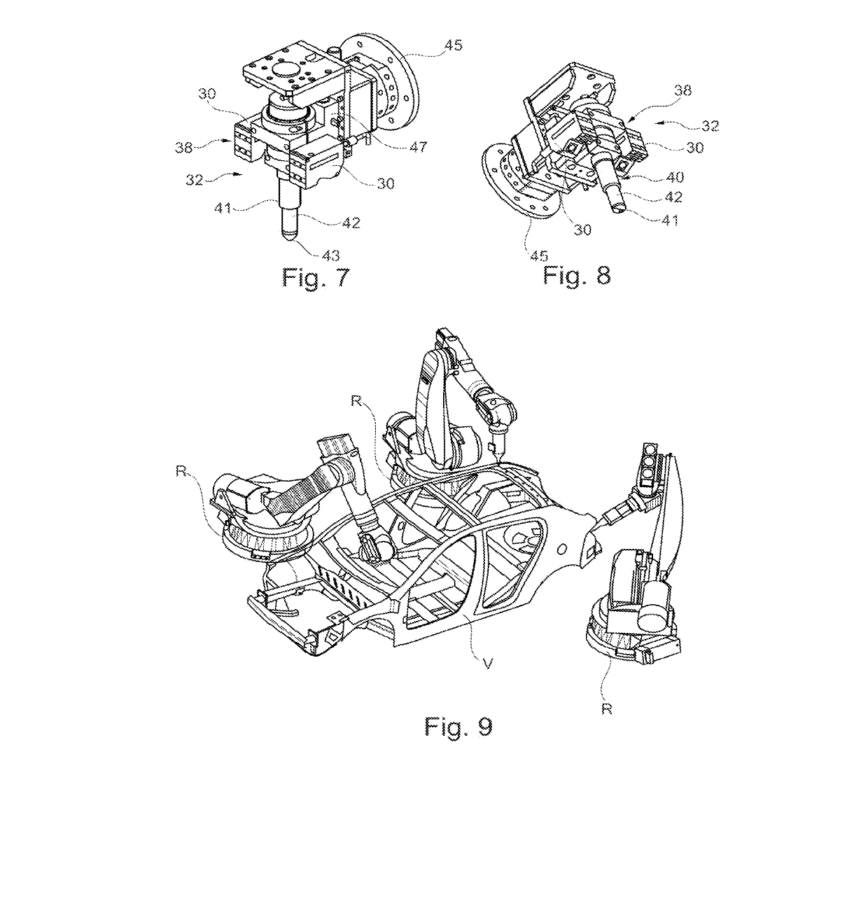

In the example illustrated, the peening technology is ultrasound-based with a vibration amplitude lying between 5 and 200 μm peak-to-peak (p/p). In the example illustrated, as may be seen in particular in FIGS. 7 and 8, the peening tool 41 comprises a single needle or impactor 43 in the peening head 42. The vibration frequency lies between 10 kHz and 60 kHz.

In a step 11, the robotized system is controlled to perform a peening using the peening tool 41 by following the corrected trajectory then the effector is changed again in a step 12 so as to place the effector 35 bearing the scanner tool 30 on the robot.

In a step 13, a new monitoring scan is performed on the peened zone in order, in the step 14, to check the quality of the treatment of the peened zone. If the latter is not correct at least at certain points, denoted “NOK” in FIG. 1, then, in the step 16, the specific zones to be peened are determined, the effector is changed for the robot to be provided with the effector 40 bearing the peening tool 41 in a step 17 and a new peening of the weld bead C or only of one or more defective zones is performed in the step 18.

During this monitoring scan of the peened zone, it is also possible to perform a measurement of the geometry of the peened zone, noted in the box 19, and the latter is compared to the measurement of the geometry of the zone before peening 2 of box 9. This comparison may make it possible, if appropriate, in particular if the peening is not satisfactory, to also perform a new peening of all or part of the weld bead by following the steps 16, 17 and 18.

On the other hand, if this comparison and the check culminate in a satisfactory conclusion concerning the peening performed, called “OK”, after repeat peening or not, it is possible to reposition the robotized system to perform a new peening treatment of a weld bead as illustrated in the step 20.

The geometrical measurements taken after peening may comprise data making it possible, by comparison with the geometrical measurements of the box 9, taken before peening, to obtain, as illustrated in FIG. 3B: the maximum depth b1 of peening of the weld bead C, the maximum depth b2 of peening of the base surface S, and width w of peening, the radius r of the peened zone Z.

As already indicated, the robotized system 32, illustrated partially in FIGS. 4 and 5, according to the invention, used for the implementation of the method illustrated in FIG. 1, comprises a mounting interface 45 with a coupler on the robot side 46. The robotized system 32 also comprises an effector 35 bearing a mechanical interface 49 forming a fixing plate that may be equipped if appropriate with a spatial positioning adjustment system, a coupler on the effector 48 side and a scanning tool 30 configured to register, digitize the spatial position in three dimensions of the weld bead root at any point thereof and the angle formed between the base surface S of the workpiece on which the weld has been produced and the weld bead C so as to be able to find the bisector and detection axis A. The robotized system 32 also comprises an effector 40 bearing at least one peening tool 41. It should be noted that, in this example, the mounting interface 45 makes it possible alternatively to mount on the robotized system 32 the effector 35, as illustrated in FIG. 4, and the effector 40, as illustrated in FIG. 5.

As illustrated in FIGS. 18 and 19, the TCP, that is the tool reference point or Tool Center Point, is, in this example, identical for the effector 40 and the effector 35. That makes it possible to ensure a repeatablility of the movement of the robot and to use this repeatability as a basis for reliabilizing the trajectory monitoring and the peening trajectory.

The robotized system 32 also comprises, on the effector 40, a compliance 47 provided to maintain the contact between the peening tool 41 and the weld bead C and monitor the contact force. The axis of mobility of the compliance 47 is positioned parallel to the detection axis A resulting from the spatial position of the root and of the bisector. The compliance 47 comprises a passive or active damping means. The calibrated contact force at rest that it seeks to ensure lies between 1N and 500N, better between 2N and 200N and preferentially between 70N and 100N.

In a way that cannot be seen in the drawing in the interests of clarity because it is arranged inside, the robotized system 32 also comprises, in this example, an angular compliance arranged to deflect, if necessary, the peening tool 41 toward the weld bead root to be treated in a plane substantially orthogonal to the bead. The angular compliance in fact allows an angular play of the peening tool 41 lying between 0 and 30°, better between 0 and 5°.

FIG. 6 represents another example of implementation of the method according to the invention. In the implementation of this method, the robotized system 32, illustrated in FIGS. 7 and 8, differs essentially from that illustrated in FIGS. 4 and 5 in that the effector comprises at least one scanning tool 30 and at least peening tool 40 and borne by the robotized system, not requiring a changing of effector in the implementation of the method. In this example, as may be seen, the effector 38, called combined effector, bears both a first scanning tool 30 allowing the acquisition of relief and position data arranged upstream in the direction of the trajectory on the robot, the peening tool 41 and a second scanning tool 30 allowing the acquisition of relief and position data downstream in the direction of the trajectory.

In this case, there is at the same time a monitoring and a peening that are almost simultaneous and point-by-point of the weld bead root qualified as virtually real-time correction.

The method whose steps are illustrated in FIG. 6 proceeds as follows. In a step 21, the initial trajectory of the weld bead is defined, in the same way as for the method illustrated in FIG. 1. The robotized system 32 of FIGS. 7 and 8 is used, for each point of the weld bead root, to perform the step 22 of scanning by following the initial trajectory, the step 23 of correction of the theoretical trajectory as a function of a differential calculation, the step 24 of scanning by following the corrected theoretical trajectory with a step 25 of checking of the correction of the trajectory and the step 26 of measurement of the geometry of the zone to be peened, these steps being performed using the first scanning tool 30, and the step 27 of peening by following the corrected trajectory using the peening tool 41 and the step 28 of monitoring scan of the peened zone and the step 29 of measurement of the geometry of the peened zone using the second scanning tool 30. As may be seen, the steps are substantially the same as illustrated in FIG. 1, apart from the fact that there is no changing of effector and that, instead of performing a complete scan of the part of the weld bead to be treated or of the parts of weld bead to be treated, there are performed the steps of scanning of a set of points with the first scanning tool 30 just before they are peened with the peening tool 41 then of monitoring them with the second scanning tool 30 while performing a scan of other points just before they are peened and then of monitoring them. This embodiment is called virtual real-time correction.

If necessary, as illustrated in FIG. 6, a second run is performed after having performed all of the scanning, peening and monitoring steps, to monitor and/or peen at least certain zones once again.

As may be seen in FIG. 9, it is possible to have a production line with a robotized cell in a workshop and the workpiece V, in this example a motor vehicle, is treated by a set of fixed robots R each bearing the robotized system 32 in the form of robotized arm.

As a variant, in a manner that is not illustrated, the robot or robotized system 32 may be displaced to the zone of the workpiece which is immobile in order to treat certain zones. Finally, as a variant, the robot may be stuck to the immobile piece, being fixed to the latter to treat certain parts thereof.

The peening may consist in treating only certain parts E of a single weld bead C as illustrated in FIG. 20 or several parts E of different weld beads, as illustrated in FIG. 21.

In this case, the system previously described may treat a single part E or several parts E of one and the same weld bead or of different weld beads. An entire weld bead may also be treated.

The peening produces, from a succession of impacts, a furrow, also called undercut, which is generally quite smooth. FIG. 12 illustrates, in an exaggerated manner, the result of the peening of a weld bead C on which may be seen, enlarged and schematically, the impacts I obtained on the weld bead root P, at least in the area surrounding this weld bead root P. The impacts I may, as illustrated in FIG. 13, create material folds U. The method may comprise the finishing step consisting in grinding these folds U as illustrated in FIG. 14 so as to obtain a smoother peened surface. The grinding makes it possible to crop the U-shape folds forming peening defects. In this case, the method may comprise a step of changing of effector to arrange an effector bearing a grinding or milling tool and a grinding or milling step. The grinder may, as a variant, be incorporated in the peening robot.

Examples of cutting or abrasive grinding or milling tools 50 that may be used for the grinding effector have been illustrated in FIGS. 15 and 16. In the example illustrated in FIG. 15, the tool 50 is a ball milling cutter with spherical end 51. The radius of curvature of the ball milling cutter is approximately equal to the radius of the undercut, that is to say of the zone formed around the root P by peening. In the example of FIG. 16, the tool 50 is a disk-grinder with rounded edge. The rounded edge has a radius of curvature substantially equal to the radius of the undercut.

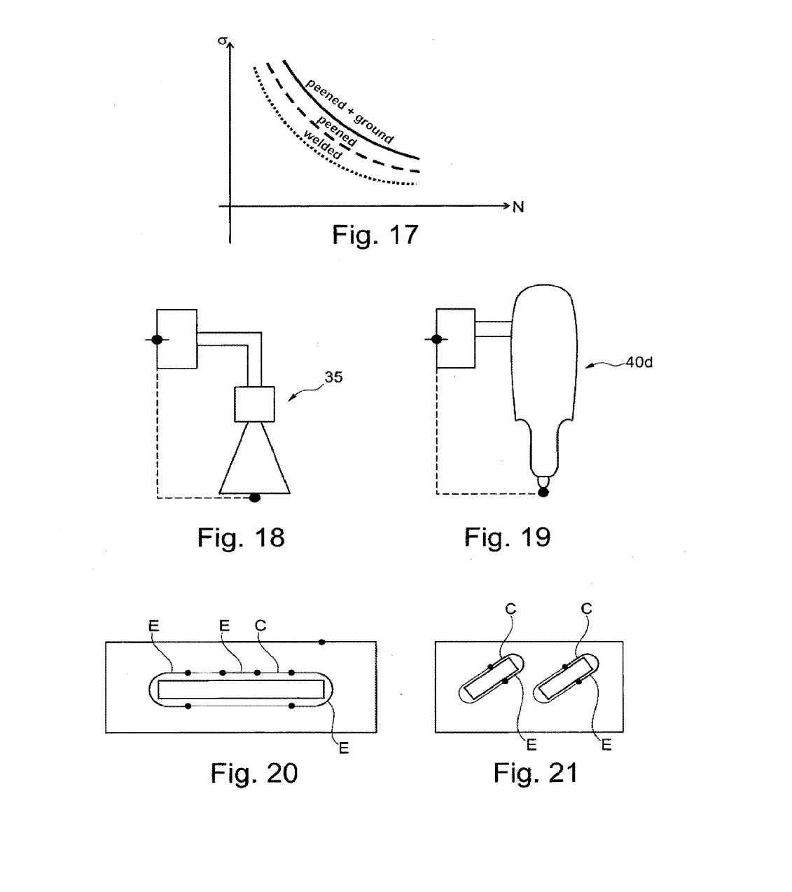

As illustrated in FIG. 17, the fatigue behavior of a weld, whatever the force exerted, offers better performance when the weld has been peened. This peened weld offers even better performance if the peening has been followed by a controlled grinding again as illustrated in this FIG. 17.

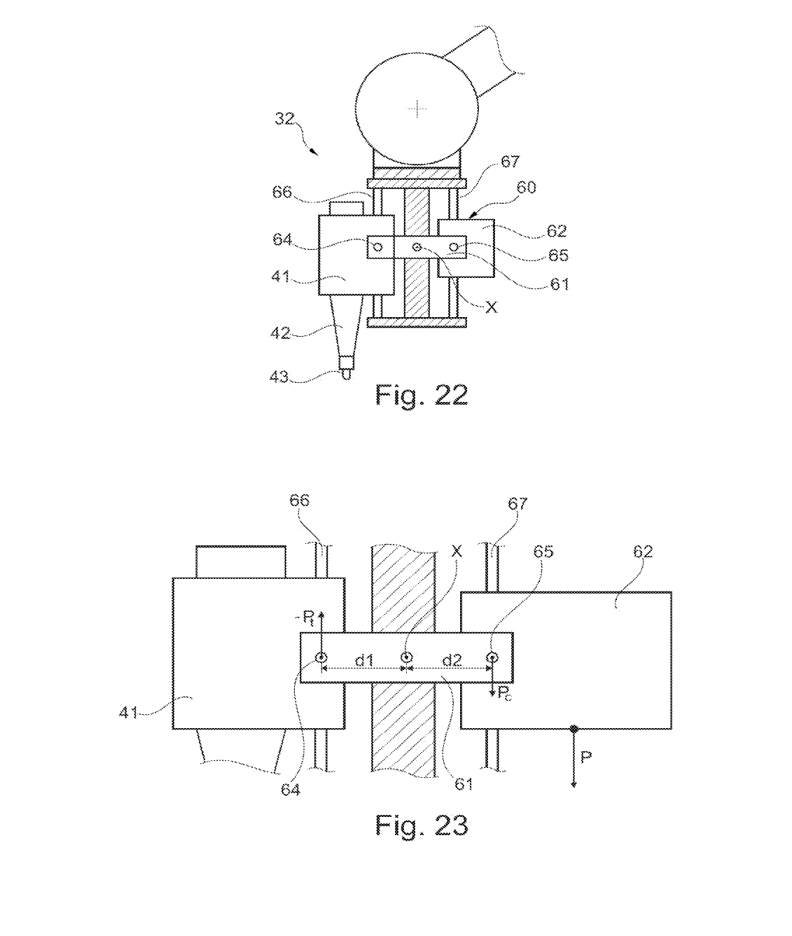

FIGS. 22 and 23 represent the possibility for the robotized system 32 to be provided with a counterweight system 60 comprising an effort-opposing transfer link rod 61, capable of pivoting about the central axis X, and a counterweight 62. The link rod 61 is, as may be seen, fixed at a point 64 to the peening tool 41 bearing the peening head 42 and the impactor 43 and, at a point 65, opposite in relation to the central axis X, to the counterweight 62. The counterweight system 60 also comprises two translation guiding axes 66 and 67. The peening tool 41 is mounted to slide on the guiding axis 66 so as to be able to be translationally displaced along the latter. The counterweight 62, for its part, is mounted to slide on the guiding axis 67 so as to be able to be translationally displaced along the latter. As illustrated in FIG. 23, a distance d₁ separates the central axis X from the point 64 and a distance d₂ separates the central axis X from the opposite point 65, on the link rod 61.

The weights Pₜ of the peening tool 41 and Pₑ of the counterweight 62 are linked by the relationship: Pₑ=dᵢ/d₂*Pₜ. If d₁=d₂, then P_{c}=P₁.

The counterweight system 60 is configured to compensate the weight of the peening tool 41, whatever its orientation, inclined or straight. The presence of the counterweight system 60 makes it possible to more easily ensure that the peening head applies an effort that is constant during the peening.

1. A method for robotized peening of a weld bead produced on a base surface of a metal workpiece using a robotized system, comprising:
controlling the robotized system provided with an effector bearing a scanning tool to follow, with the scanning tool, an initial trajectory along the weld bead, this initial trajectory having been determined from the numerical model of the piece or of the real workpiece;
acquiring, using the scanning tool, along the initial trajectory, local data on the relief and position of the weld bead and on the zone or zones of the base surface in proximity to the weld bead;
calculating, from the relief and position data thus acquired and from the initial trajectory, a corrected trajectory; and
controlling the robotized system provided with an effector bearing a peening tool for peening the weld bead along this corrected trajectory.

2. The method as claimed in claim 1, wherein the local data on the relief and position of the weld bead comprise, for any point of the weld bead, the spatial coordinates of the root of the weld bead and the angle formed at the root between the weld bead and the base surface of the workpiece.

3. The method as claimed in claim 1, further comprising a step of monitoring the corrected trajectory consisting in:
controlling the robotized system provided with the effector bearing the scanning tool to follow, with the scanning tool, the corrected trajectory,
acquiring, using the scanning tool, along the corrected trajectory, local data on the relief and position of the weld bead, and
comparing the new scanned trajectory and the corrected trajectory.

4. The method as claimed in claim 2, further comprising: the step of monitoring the corrected trajectory comprising the taking of geometrical measurements of the surface to be peened.

5. The method as claimed in claim 1, further comprising, after the peening step a quality control step consisting in controlling the robotized system provided with the effector bearing the scanning tool to acquire local data on the relief and position of the peened weld bead, in order to monitor and quantify the quality thereof.

6. The method as claimed in claim 4, further comprising, after the peening step a quality control step consisting in controlling the robotized system provided with the effector bearing the scanning tool to acquire local data on the relief and position of the peened weld bead, in order to monitor and quantify the quality thereof, the quality control step comprising the taking of geometrical measurements of the peened surface, and the comparison with the taking of geometrical measurements of the surface to be peened, in order to conclude on the quality of the peening.

7. The method as claimed in claim 6, further comprising, if the quality of the peening is deemed insufficient, a subsequent step of peening of all or part of the peened surface by control of the robotized system provided with the effector bearing the peening tool along the corrected trajectory.

8. The method as claimed in claim 1, further comprising a step of control of the robotized system provided with an effector bearing a grinding or milling tool along the corrected trajectory in order to perform a finishing of the peened surface.

9. The method as claimed in claim 1, further comprising at least one step of changing of effector, the robotized system being provided either with an effector bearing the peening tool capable of performing the peening step or steps, or an effector bearing the scanning tool capable of performing the step or steps of acquisition of local data on the relief and position of the weld bead.

10. The method as claimed in claim 1, wherein no step of changing of effector is provided, the robotized system being provided with an effector bearing both at least the scanning tool and the peening tool, and the grinding or milling tool.

11. A robotized system for implementing the method as claimed in claim 1, comprising at least one effector comprising at least:
a scanning tool configured to acquire local data on the relief and the position of the weld bead, and
a peening tool configured to perform a peening treatment of said weld bead.

12. The robotized system as claimed in claim 11, the robotized system being provided alternatively with an effector bearing said at least one scanning tool and an effector bearing the peening tool, the effectors bearing the scanning tool and the peening tool being configured such that the reference point of the tool is identical for the effector bearing the peening tool and the effector bearing the scanning tool.

13. The robotized system as claimed in claim 12, the robotized system being provided with a single effector bearing said at least one scanning tool and said at least one peening tool.

14. The robotized system as claimed in claim 11, comprising a compliance provided to maintain the contact between the peening tool and the weld bead during the peening and to monitor the contact force, the compliance being situated in a detection axis resulting from the spatial position of the root of the weld bead and of the bisector, the compliance comprising a passive or active damping means, the calibrated contact force at rest lying between 1N and 500N.

15. The robotized system as claimed in claim 11, further comprising an angular compliance, arranged to deflect, if necessary, the peening tool toward the root of the weld bead to be treated in a plane substantially orthogonal to the bead, the angular compliance allowing an angular play of the peening tool lying between 0 and 30°.

16. The robotized system as claimed in claim 11, further comprising an effector bearing a grinding or milling tool or the effector bearing a grinding or milling tool.

17. The robotized system as claimed in claim 11, wherein the scanning tool is chosen from the group composed of the contact-based systems for acquiring relief and position data and the contactless systems for acquiring relief and position data.

18. The robotized system as claimed in claim 11, wherein the peening technology of the peening tool is chosen from the group composed of ultrasound, pneumatic, linear mechanical and linear electric motor peening.

19. The robotized system as claimed in claim 11, further comprising a counterweight system configured to compensate the weight of the peening tool whatever the orientation thereof.
